(19) United States
(12) Patent Application Publication
(10) Pub. No.: US 2017/0291815 A1
(43) Pub. Date: Oct. 12, 2017

(54) Machine train for producing nitric acid

(71) Applicant: MAN Diesel & Turbo SE, Augsburg (DE)

(72) Inventors: Kai ZIEGLER, Duesseldorf (DE); Stefan UBBEN, Kempen (DE); Marco ERNST, Ratingen (DE); Klaus HÖRMEYER, Duesseldorf (DE); Roland EMMRICH, Duesseldorf (DE)

(73) Assignee: MAN Diesel & Turbo SE

(21) Appl. No.: 15/479,967

(22) Filed: Apr. 5, 2017

(30) Foreign Application Priority Data
Apr. 6, 2016 (DE) DE10 2016003950.7

(51) Int. Cl. C01B 21/40; F04D 25/16; F04D 19/02; F01D 1/20; F04D 17/10

(52) U.S. Cl. CPC C01B 21/40; F01D 1/20; F04D 17/10; F04D 19/02; F04D 25/16

(57) ABSTRACT

A machine train for producing nitric acid includes: a steam turbine having a steam turbine rotor rotating at a first rotational speed; a first compressor having a first compressor rotor rotating at a second rotational speed; a second compressor having a second compressor rotor rotating at a third rotational speed; and an expander having an expander rotor rotating at a fourth rotational speed. The steam turbine drives the first compressor. The rotor of the first compressor drives the second compressor. The expander drives the second compressor. The second compressor is configured and efficiency optimized with respect to its third rotational speed such that during operation of the machine train the first rotational speed of the steam turbine, the second rotational speed of the first compressor, the third rotational speed of the second compressor and the fourth rotational speed of the expander are equal,

### BACKGROUND OF THE INVENTION

### 1. Field of the Invention

The present invention relates to a machine train for producing nitric acid according to the two-pressure method, in which the combustion of the employed ammonia takes place at a first, low pressure by compressed process air and the nitrous gas formed through the combustion is at least partially absorbed by water at a second, comparatively higher pressure than the first pressure, as a result of which the nitric acid is created, and the residual gas that is not absorbed is expanded in a residual gas expander from the second pressure to ambient pressure for the purpose of extracting compressor work.

### 2. Description of the Related Art

The substances and substance mixtures and reaction equations employed for producing nitric acid are described in EP 0 945 400 B1, which is hereby incorporated by reference in its entirety. An essential step of the method lies in that air oxygen required for a chemical reaction is supplied. To this end, process air is compressed and brought up to a high pressure. For producing the nitric acid it is necessary, among other things, that nitrogen dioxide (NO₂) chemically reacts with water (H₂O) and oxygen (O₂). For this chemical reaction to be effective, the nitrogen dioxide should be available at a higher pressure. Preferentially, this pressure should lie between 4 and 14 bar.

Single-train nitric acid plants are known, which have a capacity between 100 and 1,000 t of daily production of nitric acid. Single-train nitric acid plants, which operate according to the two-pressure method, are designed as described in the following and shown schematically in FIG. 1. A single train is formed as single rotor train, wherein a steam turbine 1 on the one side N1 drives the train and a part gas expander 4 (axial expander) is arranged on the other side N2 of the train, which is likewise designed for driving the entire train,

An NO compressor 2 or nitrous gas compressor (radial compressor) is connected on one side to the steam turbine 1 and to an air compressor 3 (axial compressor) on the other side in a rotationally fixed manner and the air compressor 3 (axial compressor) is connected to a part gas expander 4 (axial expander) on the other side in a rotationally fixed manner. The steam turbine 1 is coupled to the NO compressor 2 via a coupling K10. The NO compressor 2 is coupled to a spur gear 100 via a coupling K20. The spur gear 100 is coupled to the air compressor 3 via a coupling K30. The air compressor 3 is coupled to the gas expander via a coupling K40.

These nitric acid production plants of single-train design have the disadvantage that the nitrous gas and air compressors used with such train arrangements in the past have different rotational speed for their optimal operation, so that between the nitrous gas compressor and the air compressor the spur gear 100 with couplings has to be arranged and the axial length accordingly is relatively great. In addition, the spur gear 100 itself results in losses, which further diminishes the overall efficiency of the train.

The arrangement of the gear 100 between the fast-running train part N1 (steam turbine 1 and nitrous gas compressor 2) and the slow-running train part N2 (air compressor 3 and expander 4) is necessary in the prior art since, due to its design, the air compressor 3 (axial compressor) cannot realize the high rotational speeds considered optimal for the steam turbine 1 and the nitrous gas compressor 2 (radial compressor).

A design for a plant for producing nitric acid that is fundamentally distinct from the aforementioned machine train is described in EP 0 945 400 B1, wherein this nitric acid plant also operates according to the two-pressure method. A substantial feature of this nitric acid plant is that the air compressor, the nitrous gas compressor and the part gas expander are combined in a geared machine and thus form a multi-shaft radial turbo compressor. Plants according to such a construction principle however have the disadvantage that on the one hand there is again a gear affected by losses and on the other hand the construction height of the geared machine is relatively high because of the large wheel.

There is therefore a need for machine trains for producing nitric acid that can be operated more effectively and accordingly with lower losses. Furthermore there is a need for reducing the installation space requirement of such a machine train, in order to be able to position the machine train in buildings of smaller dimensions with reduced length and height.

### SUMMARY OF THE INVENTION

Starting out from this, it is an object of the invention to create a new type of machine train for producing nitric acid.

This object is achieved through a machine train for producing nitric acid comprising: a steam turbine with a steam turbine rotor, configured for rotation with a rotational speed n10, a first compressor with a first compressor rotor, configured for rotation with a rotational speed n20, a second compressor with a second compressor rotor, configured for rotation with a rotational speed n30, and an expander with an expander rotor, configured for rotation with a rotational speed n40.

In one aspect, the steam turbine is configured as drive unit for the first compressor and its rotor is operationally connected to the rotor of the first compressor via a first coupling.

In another aspect, the rotor of the first compressor is operationally connected to the rotor of the second compressor via a second coupling and drives the second compressor.

In another aspect, the expander is configured as drive unit for the second compressor and its rotor is operationally connected to the rotor of the second compressor via a third coupling.

According to an aspect of the invention, during operation of the device, the rotational speeds n10 of the steam turbine, the rotational speeds n20 of the first compressor, the rotational speeds n30 of the second compressor and the rotational speeds n40 of the expander are always identical since no gears for step-down or step-up transmission of the respective rotational speeds are arranged between any of the aforementioned machines of the machine train.

The first compressor can be configured as radial compressor (single or multi-stage) and the second compressor can be configured as a multi-stage axial compressor.

The machine components of the machine train according to the invention only have one common rotational speed of the train, no gears, and also fewer couplings than the known arrangements from the prior art. In particular, the air compressor (second compressor) used for realizing this invention has an essential influence for achieving the common rotational speed of the train. The configuration of the air compressor makes possible an increase of the rotational speed by 30-40% compared with the air compressors from the prior art, as a result of which the design of the expander used with the invention is also positively influenced since, because of the higher rotational speed, even smaller expander types are sufficient for achieving the desired drive output by the expander.

During the course of the considerations for a new concept for a machine train for producing nitric acid it has now transpired that according to the past arrangement principles the optimum for the entire machine train and for its individual machine components is not attained, in particular with respect to their efficiencies and the entire installation space and the costs.

In particular by analyzing the individual machine components it has transpired that by omitting a gear between the first and the second compressor (arrangement according to the prior art) on the one hand the costs for the gears no longer apply and on the other hand the installation space can be significantly reduced and thus the machine train configured substantially more efficiently.

During the course of the analysis it has transpired that omitting the gears cannot be realized without further measures with respect to the configuration of individual machine components of the machine train, for the machine components of the machine train used in the past do not have any uniform optimal rotational speed ranges, which is required for leaving out the gears.

According to another aspect of the invention, the second compressor, which is preferentially designed as air compressor, is now configured with respect to its optimized rotational speed so that during the operation of the machine train the rotational speeds n10 of the steam turbine, the rotational speeds n20 of the first compressor, the rotational speeds n30 of the second compressor and the rotational speeds n40 of the expander are equal.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are described by way of the description and the figures. Components marked with the same reference numbers have the same functionality. In the drawings:

FIG. 1 shows a schematic representation of a machine train for producing nitric acid according to the prior art; and

FIG. 2 shows a schematic representation of an inventive machine train for producing nitric acid.

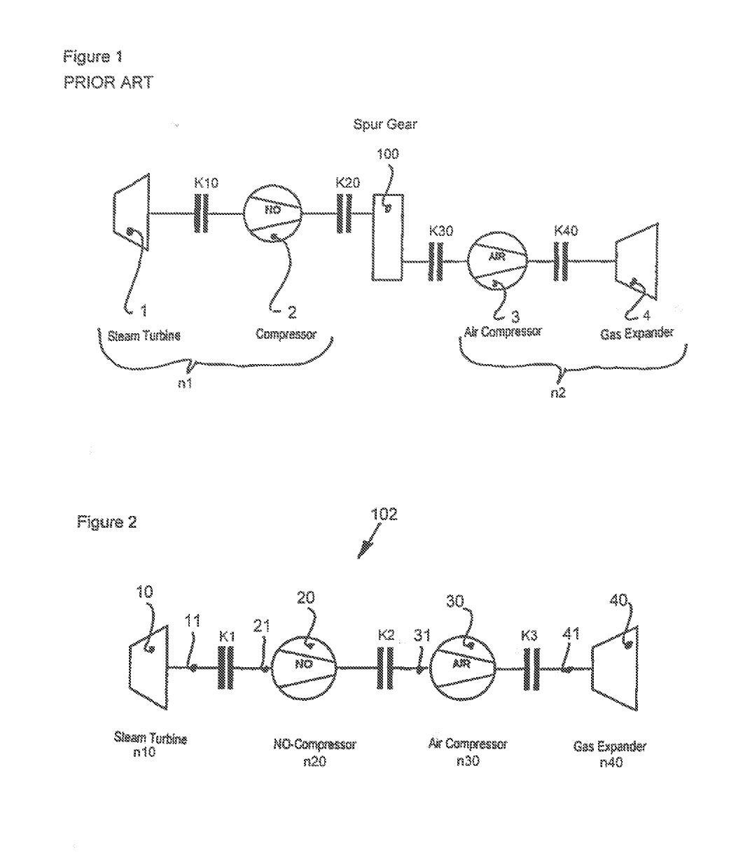

### DETAILED DESCRIPTION OF THE PRESENTLY PREFERRED EMBODIMENTS

In EP 0 945 400 B1 the method for producing nitric acid is described. Furthermore, a plant for producing nitric oxide is described in this patent publication and, in addition to this, substantial chemical reaction equations applied during the production of nitric acid are shown.

The entire content of the patent publication EP 0 945 400 B1 is hereby incorporated by reference in its entirety in this application.

The description of FIG. 2 relates in particular to the required compressor units. With respect to individual process sequences, reference is made to EP 0 945 400 B1.

The inventive machine train for producing nitric acid is schematically shown in FIG. 2. The machine train (102) for producing nitric acid comprises a steam turbine (10) with a steam turbine rotor (11), which is configured for rotation with a rotational speed n10, a first compressor (20) with a first compressor rotor (21), which is configured for rotation with a rotational speed n20, a second compressor (30) with a second compressor rotor (31), which is configured for rotation with a rotational speed n30, an expander (40) with an expander rotor (41), which is configured for rotation with a rotational speed n40.

The steam turbine (10) is configured as a drive unit for the first compressor (20) and its rotor (11) is operationally connected to the rotor (21) of the first compressor (20) via a first coupling (K1).

The rotor (21) of the first compressor (20) is operationally connected to the rotor (31) of the second compressor (30) via a second coupling (K2) and drives the second compressor (30).

The expander (40) is configured as a drive unit for the second compressor (30) and its rotor (41) is operationally connected to the rotor (30) of the second compressor via a third coupling (K3).

The second compressor (30) is configured with respect to its efficiency-optimized rotational speed n30 such that during the operation of the machine train (102) the rotational speeds n10 of the steam turbine (10), the rotational speeds n20 of the first compressor (20), the rotational speeds n30 of the second compressor (30) and the rotational speeds n40 of the expander (40) are equal.

In a preferred further development of the invention, the first compressor is configured as radial compressor and the second compressor as axial compressor.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A machine train (102) for producing nitric acid, comprising:
a steam turbine (10) having a steam turbine rotor (11) configured to rotate at a first rotational speed (n10);
a first compressor (20) having a first compressor rotor (21) configured to rotate at a second rotational speed (n20);
a second compressor (30) having a second compressor rotor (31) configured to rotate at a third rotational speed (n30); and
an expander (40) having an expander rotor (41) configured to rotate at a fourth rotational speed (n40),
wherein the steam turbine (10) is configured to drive the first compressor (20), and the rotor (11) of the steam turbine (10) is operationally connected to the rotor (21) of the first compressor (20) via a first coupling (K1),
wherein the rotor (21) of the first compressor (20) is operationally connected to the rotor (31) of the second compressor (30) via a second coupling (K2) and drives the second compressor (30).
Therein the expander (40) is configured to drive the second compressor (30) and the rotor (41) of the expander (40) is operationally connected to the rotor (30) of the second compressor via a third coupling (K3), and
wherein the second compressor (30) is configured and efficiency optimized with respect to its third rotational speed (n30) such that during operation of the machine train (102) the first rotational speed (n10) of the steam turbine (10), the second rotational speed (n20) of the first compressor (20), the third rotational speed (n30) of the second compressor (30) and the fourth rotational speed (n40) of the expander (40) are equal.

2. The machine train according to claim 1, wherein the first compressor (20) is a radial compressor.

3. The machine train according to claim 1, wherein the second compressor (30) is an axial compressor.
